(19) United States
(12) Patent Application Publication
(10) Pub. No.: US 2012/0035362 A1
(43) Pub. Date: Feb. 9, 2012

(54) PHOSPHORAMIDITE DERIVATIVES OF FOLIC ACID

(75) Inventors: Nancy Sue Barta, Brighton, MI (US); John Cooke Hodges, Ann Arbor, MI (US)

(73) Assignee: Berry and Associates, Inc., Dexter, MI (US)

(21) Appl. No.: 13/195,507

(22) Filed: Aug. 1, 2011

Related U.S. Application Data
(60) Provisional application No. 61/370,185, filed on Aug. 3, 2010.

(51) Int. Cl. C07F 9/02

(52) U.S. Cl. 544/244

(57) ABSTRACT

The present invention provides for compounds of Formula I:

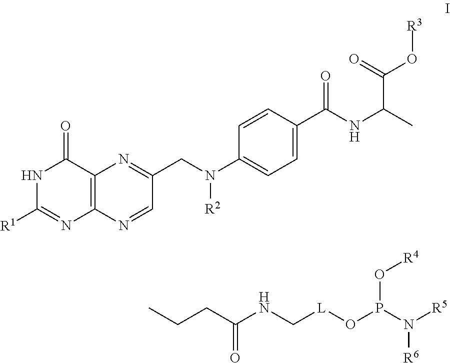

wherein L and R¹-R⁶ have any of the values defined there for in the specification. The compounds of formula I are useful as reagents to form folic acid conjugates with hydroxyl-containing compounds of interest, such as oligonucleotides and anti-cancer compounds.

### FIELD OF THE INVENTION

The present invention relates generally to phosphoramidite derivatives of folic acid that are suitable for use in the conjugation of folic acid to other molecules of interest. In particular, this invention pertains to chemically protected folic acid derivatives in which the γ-carboxylic acid is covalently connected to a linker fragment, which bears a reactive phosphoramidite group at its distal end. This phosphoramidite group provides a convenient basis for covalent bond formation with a hydroxyl group on the molecule of interest under mild conditions, thereby providing a phosphodiester group at the linkage site. The phosphodiester group is particularly applicable to folic acid conjugates when the molecule of interest is DNA, RNA, or an anticancer compound.

### BACKGROUND

Folic acid (i) is a cofactor for various intracellular enzymes that are critical to the survival and proliferation of cells.

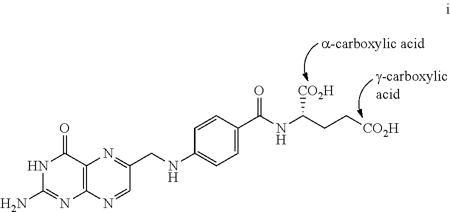

In most mammals, folic acid is obtained exclusively through diet and therefore, is considered an essential vitamin. Trans-membrane transport receptors provide a means of promoting the absorption of folic acid from the gut and distribution into cells throughout the body. Chemically tagging molecules that do not easily cross cell membranes with folic acid (or structural mimics of folic acid) can improve their ability to penetrate into cells. Man-made folate conjugates such as structures ii and iii represent useful approaches to medicines and medical diagnostic agents.

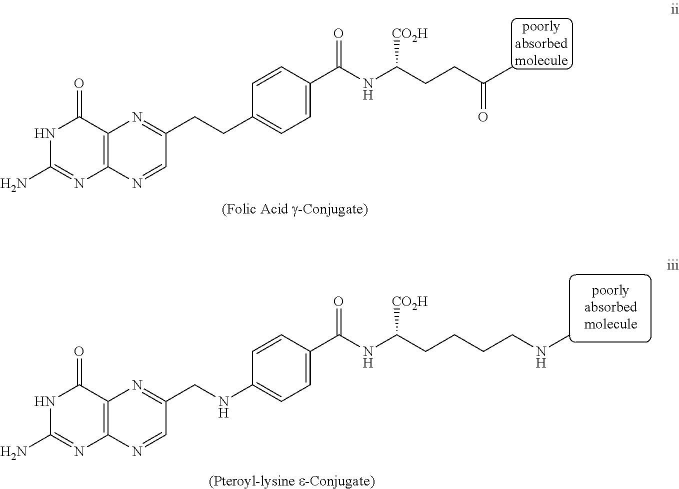

In particular, folate conjugates may represent useful approaches to anticancer medicines and cancer diagnostic agents since certain cancers are known to over-express folate receptors in their cell membranes. The folate moiety of the folate-drug conjugate mediates the uptake of the folate-drug conjugate into the cancer cell. Three examples of folate conjugates acting as anticancer medicines and cancer diagnostics are compounds iv-vi:

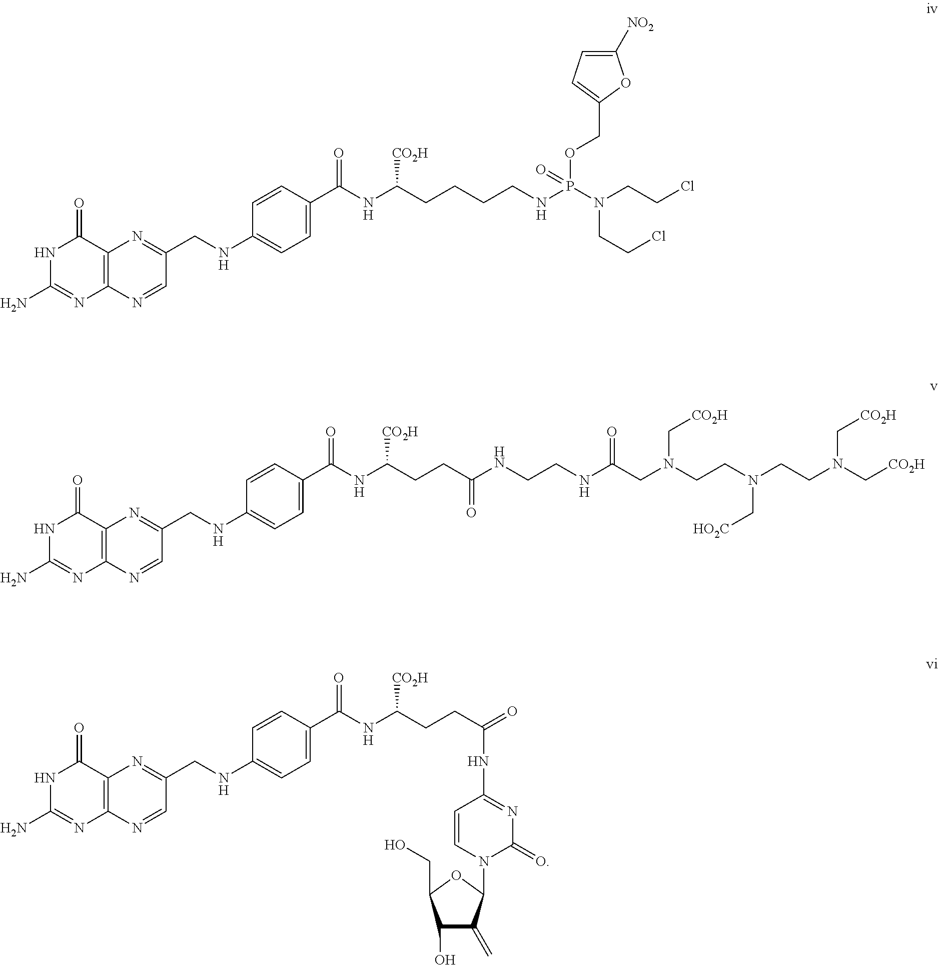

A design for cancer drug-folate conjugates has been described by Steinberg and Borch, J Med. Chem. 2001, 44, 69-73. Their approach involves the construction of the pteroyl-lysine-ε-phosphoramidate, iv as a prodrug in an effort to improve the bioavailability and cellular penetration of the nitrofuran-phosphoramidate drug through active folate transport. The metal binding ligand known as DTPA folate (γ) (v), which has been described by Luo, et al., J. Am. Chem. Soc., 1997, 119, 10004-10013, has utility as a tumor imaging agent. The synthesis of a folate-DMDC conjugate (vi) and its potent activity as an antitumor nucleoside have been described by Nomura, et al., J. Org. Chem., 2000, 65, 5016-5021. In this case the γ-carboxylic acid of folic acid acylates the amino group of the cytosine base. The drug DMDC (1-(2-deoxy-2-methylene-β-D-erythro-pentofuranosyl)cytosine) is an antitumor nucleoside.

The use of folic acid conjugation to enhance the membrane transport of oligonucleotides has been reported in U.S. Pat. No. 6,335,434. An example of a folate-nucleoside phosphoramidite conjugate from U.S. Pat. No. 6,335,434 (vii) is:

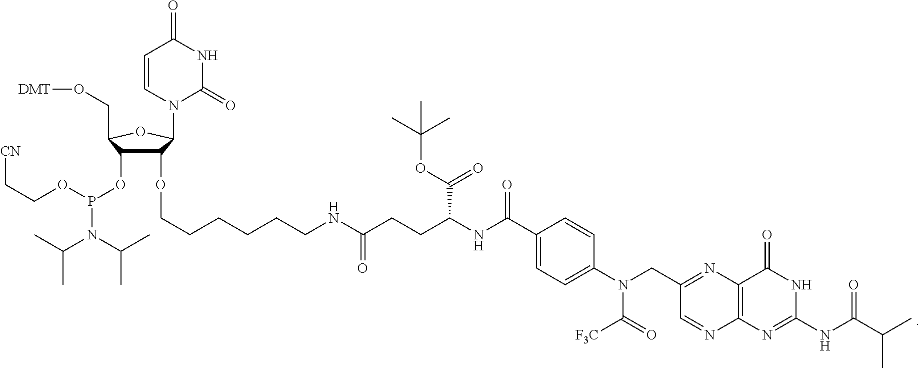

The inclusion of folate, a folate analog, a folate mimic, or a folate receptor binding ligand in an iRNA agent has been described Manoharan, et al., PCT Publication WO 2009/082606. The solid support, viii, which allows for the conjugation of folic acid to the 3′-terminus of an oligonucleotide has been reported by Kazanova, et al., Nucleosides, Nucleotides and Nucleic Acids, 26, 1273-6, 2007.

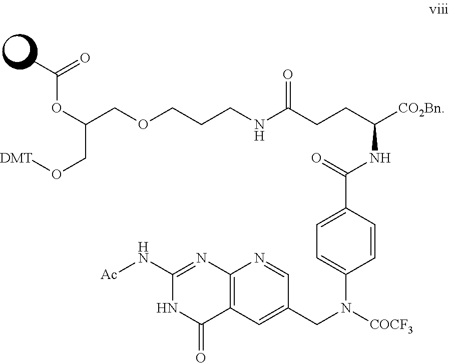

There is a need in the art for additional folate derivatives which can be conjugated to compounds such as oligonucleotides and anticancer compounds, and provide improved properties for the resulting folate conjugates.

### DEFINITIONS

1. “Aryl” means an unsubstituted phenyl ring, or a phenyl ring that is substituted with one to five substituents independently selected from the group consisting of: F, Cl, Br, I, OR, OPh, CF₃, CCl₃, or C₁-C₆-alkyl.
2. “Bis-reagent” means 3-((bis(diisopropylamino)phosphino)oxy)propanenitrile or (i-Pr₂N)₂POCH₂CH₂CN.
3. “C₁-C₆-alkyl” means a monovalent radical of a straight or branched alkane having from one to six carbons, or a 3-6 membered cycloalkane. Examples of C₁-C₆ straight-chain alkyl groups include methyl, ethyl, n-propyl, n-butyl, n-pentyl, and n-hexyl. Examples of branched-chain alkyl groups include, but are not limited to, isopropyl, tert-butyl, isobutyl, isoamyl, neopentyl, etc. Examples of 3-6 membered cycloalkyl include, but are not limited to, cyclopropyl, cyclobutyl, cyclopentyl, cyclohexyl, cyclopropylmethyl, 1-methylcyclopropyl, 2-methylcyclopropyl, 1-cyclopropyl-ethyl, 2-cyclopropyl-ethyl, 1-cyclopropyl-propyl, 2-cyclopropyl-propyl, 3-cyclopropyl-propyl, cyclobutylmethyl, 1-cyclobutyl-ethyl, 2-cyclobutyl-ethyl, 2-methylcyclopentyl, and cyclopentylmethyl.
4. “Chloro-reagent” means 3-((chloro(diisopropylamino)phosphino)oxy)propanenitrile or i-Pr₂NP(Cl)OCH₂CH₂CN.
5. “Heteroatom” means a nitrogen atom, an oxygen atom, or a sulfur atom.
6. “Nucleoside” means the repeating synthon of RNA or DNA that is composed of a heterocyclic base and a ribose or a 2-deoxyribose. As used in this disclosure, nucleoside refers to both natural and unnatural nucleosides that are known by those skilled in the art to be useful to oligonucleotide synthesis. Examples of natural nucleosides include uridine, cytosine, adenosine, guanosine, inosine, thymidine, 2′-deoxyuridine, 2-deoxycytosine, 2′-deoxyadenosine, 2′-deoxyguanosine and 2′-deoxyinosine. Examples of unnatural nucleosides include, but are not limited to, those analogs of natural nucleosides with one or more of the following five types of modifications to the heterocyclic base: (1) a ring nitrogen atom of the heterocyclic base has been replaced by a carbon atom; (2) a ring carbon atom of the heterocyclic base has been replaced by a nitrogen atom; (3) an oxygen atom or hydroxyl group of the heterocyclic base has been replaced by a hydrogen atom, a chlorine atom, a fluorine atom, a sulfur atom or thiol group, an amino group, a nitro (NO₂) group, or a C₁-C₆-alkyl group; (4) an amino group of the heterocyclic base has been replaced by a hydrogen atom, a chlorine atom, a fluorine atom, a hydroxyl group, a thiol group, a nitro (NO₂) group, or a C₁-C₆-alkyl group; and (5) a hydrogen atom of the heterocyclic base has been replaced by an amino group, a hydroxyl group, a thiol group, a nitro (NO₂) group, or a C₁-C₆-alkyl group.
7. “Nucleoside phosphoramidite” means a synthon of RNA or DNA that is a nucleoside wherein all but one of the hydroxyl groups on the ribose or deoxyribose are suitably protected and the remaining hydroxyl group is activated as a phosphoramidite, rendering the nucleoside useful for oligonucleotide synthesis. For example, in a typical nucleoside phosphoramidite the 5′-hydroxyl group is suitably protected by DMT, the 3′ hydroxyl group is activated as an N,N-di-isopropylamino, 2-cyanoethoxy-phosphoramidite, and if there is a 2′-hydroxyl group present, it is suitably protected by one of the following groups: —CH₃, —Si(t-Bu)Me₂, —Si(t-Bu)Ph₂, —CH₂OSi(i-Pr)₃, or —CH(OCH₂CH₂OAc)₂.
8. “Nucleotide” means a synthon of RNA or DNA that is composed of a heterocyclic base, a ribose or a deoxyribose, and a phosphate. As used in this disclosure, nucleotide refers to both natural and unnatural nucleotides that are known by those skilled in the art to be useful to oligonucleotide science.
9. “Modifier” means a synthon that adds a functional group with useful reactivity, such as for example an amino group, a thiol group or a carboxyl group, to an oligonucleotide, peptide, or polysaccharide. Typically a modifier is attached with the useful functional group in protected form then the protecting group is removed when the reactivity of the useful functional group is required.
10. “Oligonucleotide” means a segment of single stranded DNA or RNA, typically fewer than 100 nucleotides in length. As used in this disclosure, oligonucleotides may be composed of both natural and unnatural nucleotides and may contain other modifiers and tags that are known in the art to be useful in oligonucleotide synthesis.
11. “Phosphoramidite” means a phosphorous (III) moiety with two ester and one amide linkages.
12. “Phosphityl” means a phosphorous (III) moiety.
13. “Synthon” means a chemical fragment that comprises a portion of the final product of a multi-step organic synthesis. The heteratoms of a synthon may or may not have protecting groups attached, depending on the stage of a synthesis.
14. “Tag” means a chemical fragment that enables the detection, facilitates the purification, and/or modifies the biological properties of an oligonucleotide. Examples of tags include fluorescent moieties such as fluorescein, tetramethyrhodamine, tetraethylrhodamine, and dansyl; quencher dyes such as dabsyl, dabcyl, and BBQ-650; biotin and desthiobiotin; folic acid; and photoaffinity groups such as aryl azide and benzophenone, fluorous protecting groups, azides, and alkynes.

Abbreviations of specific terms used in this disclosure:

1. “Ar” means an aryl group, as defined above.
2. “Ac” means acetyl or COCH₃.
3. “Boc” means t-butyloxycarbonyl.
4. “Cbz” means benzyloxycarbonyl.
6. “CEP” means 2-cyanoethyloxy-N,N-diisopropylamino-phosphityl.
7. “CPG” means controlled pore glass, a solid support that is frequently used for solid-supported oligonucleotide synthesis.
8. “DCM” means dichloromethane.
9. “DMT” means bis(4-methoxyphenyl)(phenyl)methyl, also known as dimethoxytrityl.
10. “DMF” means N,N-dimethylformamide.
11. “DNA” means (2″-deoxyribo)nucleic acid.
12. “EDAC.HCl” means ethyl, dimethylaminopropylcarbodiimide hydrochloride.
13. “ETT” means 5-(ethylthio)tetrazole.
14. “Fmoc” means (9H-fluoren-9-yl)methoxycarbonyl.
15. “HBTU” means O-(Benzotriazol-1-yl)-N,N,N′,N′-tetramethyluronium hexafluorophosphate.
16. “HOBT” means 1-Hydroxybenzotriazole.
17. “HPLC” means high pressure liquid chromatography, also known as high performance liquid chromatography.
18. “i-Pr” means isopropyl, 2-propyl, or CH(CH₃)₂.
19. “lcaa” means long chain aminoalkyl, a linker that is attached to CPG for the solid-supported synthesis of oligonucleotides which is well known to those skilled in the art of oligonucleotide synthesis.
20. “Me” means methyl or CH₃.
21. “MMT” means (4-methoxyphenyl)diphenylmethyl, also known as monomethoxytrityl.
22. “Ph” means phenyl or C₆H₅.
23. “RNA” means ribonucleic acid.
24. “SEM” means [2-(trimethylsilyl)ethoxy]methyl.
25. “T” means thymidine, a 2′-deoxyribonucleoside.
26. “T₆” means an oligonucleotide composed of six thymidines and their associated phosphodiester links.
27. “t-Bu” means tertiary-butyl or C(CH₃)₃.
28. “TFA” means trifluoroacetic acid.
29. “THF” means tetrahydrofuran.
30. “TLC” means thin layer chromatography.
31. “Tr” means triphenylmethyl, also known as trityl.

### SUMMARY OF THE INVENTION

In one aspect, the present invention provides for compounds of Formula I:

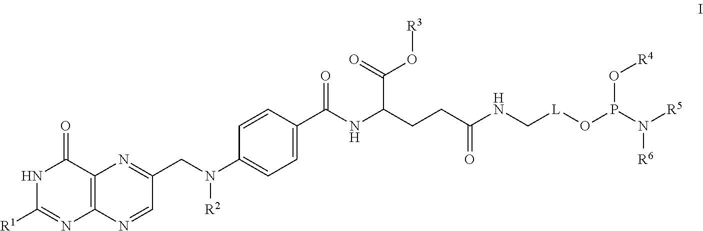

wherein: R¹ is c-hexyl-C(═O)NH, c-pentyl-C(═O)NH, (CH₃)₂CHC(═O)NH, CH₃CH₂C(═O)NH, CH₃C(═O)NH, PhC(═O)NH, 2-CH₃-Ph(C═O)NH, 4-CH₃-Ph(C═O)NH, 2,4-(CH₃)₂-Ph(C═O)NH, 2,6-(CH₃)₂-Ph(C═O)NH, 2,4,6-(CH₃)₃-Ph(C═O)NH, Fmoc-NH, (CH₃)₃SiCH₂CH₂OC(═O)NH, DMT-OCH₂CH₂OC(═O)NH, NCCH₂CH₂OC(═O)NH, Cl₃CCH₂OC(═O)NH, CH₃C(═O)OCH₂CH₂OC(═O)NH, CH₃C(═O)OCH₂CH₂C(CH₃)₂C(═O)NH, DMT-OCH₂CH₂C(CH₃)₂OC(═O)NH, DMT-OCH₂CH₂C(Ph)₂OC(═O)NH, DMT-OCH₂CH₂C(4-Cl-Ph)₂OC(═O)NH, CF₃C(═O)NHCH₂CH₂C(═O)NH, CF₃C(═O)NHCH₂CH₂C(CH₃)₂C(═O)NH, (CH₃)₂N—C═N, (i-Bu)₂N—C═N, (n-Bu)₂N—C═N, (i-Pr)₂N—C═N, (n-Pr)₂N—C═N, (Et)₂N—C═N, (CH₃)₂N—C═N, or (1-imidazolyl)-C═N; R² is CH₃C(═O), CF₃C(═O), Cl₃C(═O), Fmoc, SEM, H₂C═CHCH₂, C₂H₅, CH₃, or H; R³ is CH₃, C₂H₅, CH₂CH₂CN, CH₂CH₂Si(CH₃)₃, Cl₃CCH₂, CH₂(9-fluorenyl), or (CH₂)ₙO-DMT, wherein n is an integer from 2 to 6; R⁴ is CH₂CH₂CN or CH₃; R⁵ and R⁶ are each independently selected C₁-C₆-alkyl, or may be taken together to form —(CH₂)₄— or —(CH₂)₅—; and L is —(CH₂)ₘ—, —(CH₂CH₂O)ₘCH₂CH₂, CH₂(OCH₂CH₂)ₘ—, —(CH₂)ₘOCH₂CH(CH₂O-DMT)-, —(CH₂CH₂O)ₘ CH₂CH₂OCH₂CH(CH₂O-DMT)-, —CH₂(OCH₂CH₂)ₘOCH₂CH(CH₂O-DMT)-, —(CH₂)ₘOCH₂CH₂CH(CH₂CH₂O-DMT)-, —(CH₂CH₂O)ₘCH₂CH₂CH(CH₂CH₂O-DMT)-, —CH₂(OCH₂CH₂)ₘOCH₂CH₂CH(CH₂CH₂O-DMT)-, —(CH₂)ₘCONHCH(CH₂O-DMT)CH₂—, —(CH₂CH₂O)ₘCH₂CH₂CONHCH(CH₂O-DMT)CH₂, (CH₂CH₂O)ₘCH₂CONHCH(CH₂O-DMT)CH₂—, or —CH₂(OCH₂CH₂)ₘOCH₂CONHCH(CH₂O-DMT)CH₂—, wherein m is an integer from 1 to 10. The left end of the L groups, as written above, would each be connected to the methylene group that is connected to the nitrogen of the amide group. The right end of the L groups, as written above, would each be connected to oxygen to which L is bonded to. In certain embodiments, R¹ is c-hexyl-C(═O)NH, c-pentyl-C(═O)NH, (CH₃)₂CHC(═O)NH, CH₃CH₂C(═O)NH, CH₃C(═O)NH, PhC(═O)NH, 2-CH₃-Ph(C═O)NH, 4-CH₃-Ph(C═O)NH, or 2,4-(CH₃)₂-Ph(C═O)NH. In certain embodiments, R² is CCl₃C(═O), CF₃C(═O), or H. In particular embodiments, R³ is CH₃, C₂H₅, CH₂CH₂CN, or CH₂(9-fluorenyl). In other embodiments, R⁴ is CH₂CH₂CN, R⁵ is i-Pr, and R⁶ is i-Pr. In certain embodiments, L is (CH₂CH₂O)ₘCH₂CH₂, CH₂(OCH₂CH₂)ₘ, (CH₂CH₂O)ₘCH₂CH₂OCH₂CH(CH₂O-DMT), CH₂(OCH₂CH₂)ₘOCH₂CH(CH₂O-DMT), (CH₂CH₂O)ₘ CH₂CH₂CH(CH₂CH₂O-DMT), or CH₂(OCH₂CH₂)ₘOCH₂CH₂CH(CH₂CH₂O-DMT), wherein m is an integer from 1 to 10. In other embodiments, R¹ is (CH₃)₂CHC(═O)NH, R² is CF₃C(═O), or H, R³ is CH₃, R⁴ is CH₂CH₂CN, R⁵ is i-Pr and R⁶ is i-Pr. In certain embodiments, m is an integer from 1 to 4. In certain embodiments, a compound of formula I is represented by structure II, including all four possible individual diastereomers and mixtures thereof

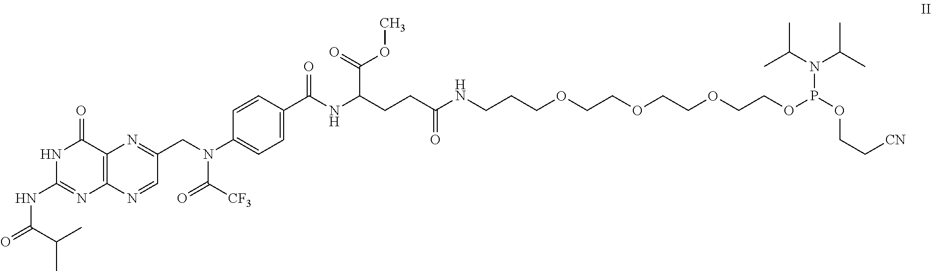

In particular embodiments, a compound of formula I is represented by structure III, including all eight possible individual diastereomers and mixtures thereof

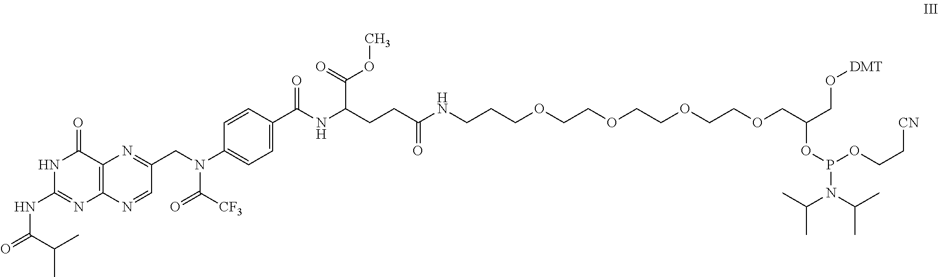

In particular embodiments, a compound of formula I is represented by structure IV, including all eight possible individual diastereomers and mixtures thereof

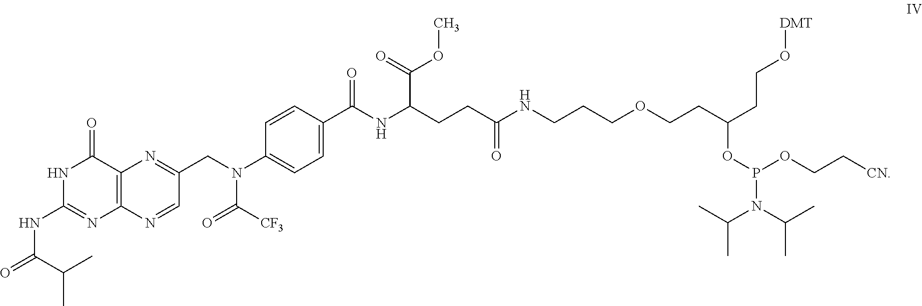

### DETAILED DESCRIPTION OF THE INVENTION

The present invention relates to folic acid derivatives of formula I. The preparation and use of these compounds is described in more detail below and in the examples.

A general synthetic route for preparing compounds of formula I is set forth in Scheme I. In the first step, a doubly protected pteroic acid derivative (1) is converted to its glutamate amide (2) using suitable amide bond forming reagents, solvents, and conditions, such as: a) HBTU and i-Pr₂NEt in DMF at room temperature, b) EDAC.HCl and HOBT in a mixture of DMF and DCM at room temperature, c) PYBOP and i-Pr₂NEt, in a mixture of DMF and DCM at room temperature, and d) i-BuOCOCl and 1-methylmorpholine in THF at 5° C. Step 2 involves the selective cleavage of the t-butyl ester by treatment with a strong acid, such as trifluoroacetic acid in dichloromethane, thereby affording the mono acid (3). Step 3, much like step 1, employs suitable amide bond forming reagents, solvents, and conditions, to acylate the amino group of the linker fragment to provide an alcohol derivative (4). The alcohol derivative (4) is converted (step 4) to a reactive phosphoramidite (I) that is suitably protected for DNA and RNA synthesis. The phosphorous III reagents for making phosphoramidites and conditions include, for example: a) bis-reagent and an acid catalyst such as tetrazole or ETT in DCM at room temperature and b) chloro-reagent and a tertiary amine base such as diisopropylethylamine or triethylamine in DCM at 5° C., warming to room temperature.

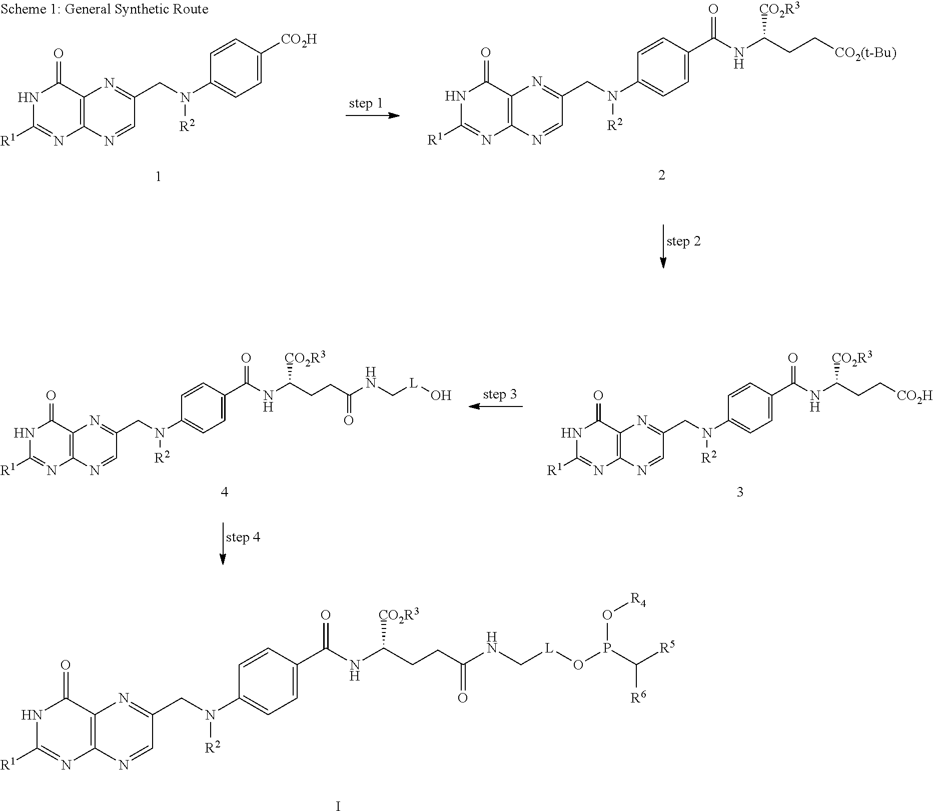

Some variation of Scheme 1 may be required for certain compounds of Formula I. It is within the realm of expertise of those skilled in the art of organic synthesis to add protection and deprotection steps, and rearrange the order of connection of various synthons in order to accommodate specific compounds of Formula I that are not optimally produced by the route shown in Scheme 1.

In certain embodiments, compounds of formula I may exist as stereoisomers, including enantiomers, and diastereomers. All of these forms, including (R), (S), epimers, diastereomers, cis, trans, syn, anti, solvates (including hydrates), tautomers, and mixtures thereof, are contemplated within the scope of formula I.

In certain embodiments, compounds of formula I, may be synthesized with stable heavy isotopes such as one or more ²H isotope in place of ¹H atoms, one or more ¹³C isotope in place of ¹²C atoms, one or more ¹⁵N isotope in place of ¹⁴N atoms, and/or one or more ¹⁸O isotope in place of ¹⁶O, Some of the compounds in the present invention may be synthesized with radioactive isotopes such as ³²P or ³³P isotopes in place of ³¹P atoms, one or more ¹⁴C isotope in place of ¹²C atoms, one or more ³H isotope in place of ¹H atoms, one or more ¹⁸F isotope in place of ¹H atoms, and/or one or more ¹²³I, ¹²⁵I, or ¹³¹I isotopes in place of ¹H atoms. Incorporation of stable heavy isotopes and radioactive isotopes is contemplated for compounds of formula I. In certain embodiments, compounds of formula I may be conjugated to DNA or RNA oligonucleotides to facilitate uptake of the conjugate into folate receptor expressing cells of medical interest. For example, a compound, such as II, may be used for conjugation of a folate moiety at the 5′-terminus of an RNA or DNA oligonucleotide. Other compounds of the present invention, such as III and IV, are designed for more flexible use with regard to conjugation of a folate moiety at the 5′-terminus, at the 3′-terminus, and at internal positions of an RNA or DNA oligonucleotide. Schemes 2, 3, and 4 illustrate the conjugating selected compounds of formula I to RNA and DNA oligonucleotides.

Insofar as the chemistry for the synthesis of RNA and DNA oligonucleotides is based upon the repeated formation of phosphotriester groups, which ultimately are deprotected to generate an oligomer that is linked by multiple phosphodiester groups, the compounds of the present invention are ideally suited for conjugation of folic acid via the same fundamental phosphorous chemistry. The art of preparation of oligonucleotides via solid supported synthesis is well understood by those skilled in the art. The chemistry has been highly optimized and is now so standardized that it is routinely performed with the aid of an automated synthesizer. The inclusion of a compound of formula I in such automated synthesis is easily accomplished. A solution of a compound of formula I in anhydrous acetonitrile is installed into the custom phosphoramidite port of the synthesizer. The desired base sequence is then programmed into the computer that controls the synthesizer. The standardized synthesis cycles are then carried out under the control of the computer and synthesizer, whereby a linear chain of phosphotriester links (the oligonucleotide) is synthesized on a solid support, typically CPG. The oligonucleotide is then cleaved from the CPG and deprotected using standard conditions, well known to those skilled in the art. The folate protecting groups in a compound of Formula I are designed to be removed under the same conditions as the protecting groups normally encountered in oligonucleotide synthesis. Hence, a compound of Formula I is easily integrated into an automated oligonucleotide synthesis environment to provide a folic acid conjugate of an oligonucleotide. Schemes 2, 3, and 4 are illustrative of the use of compounds of Formula I in the preparation of such conjugates.

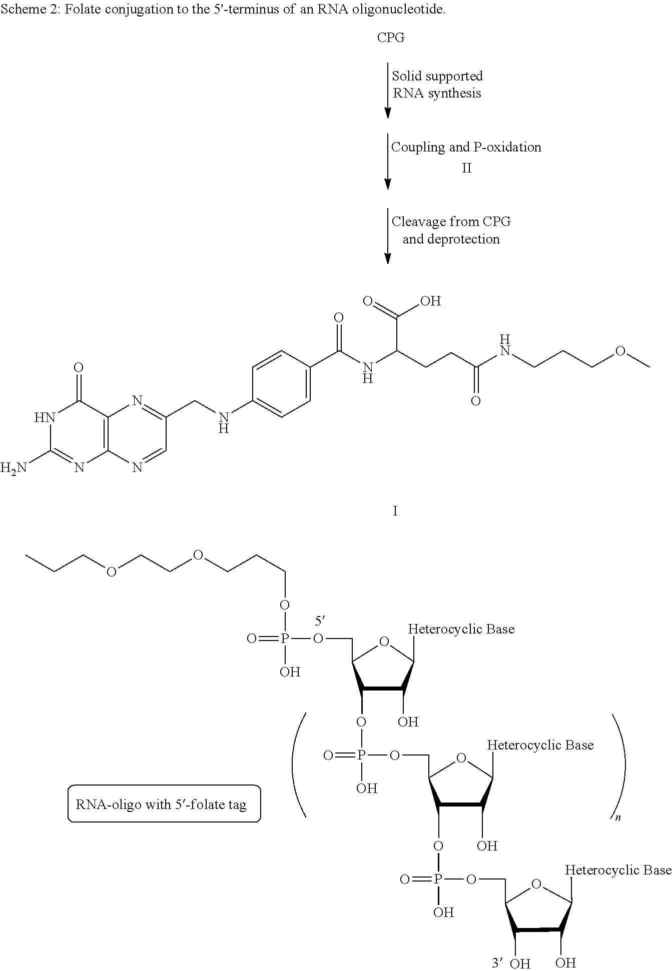

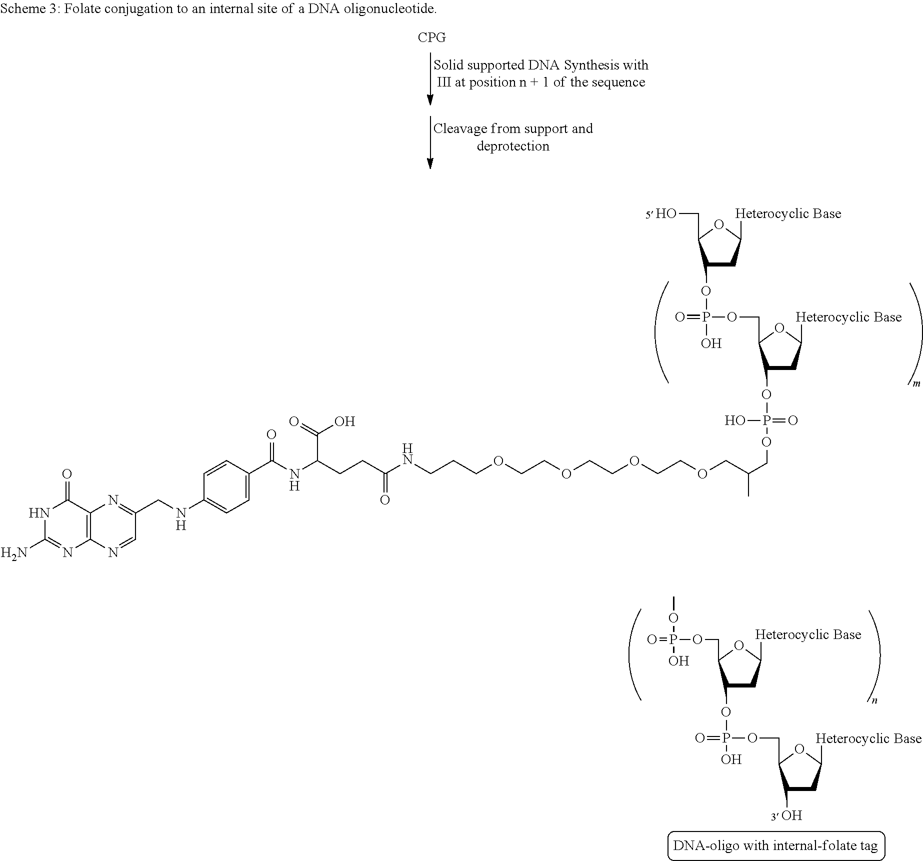

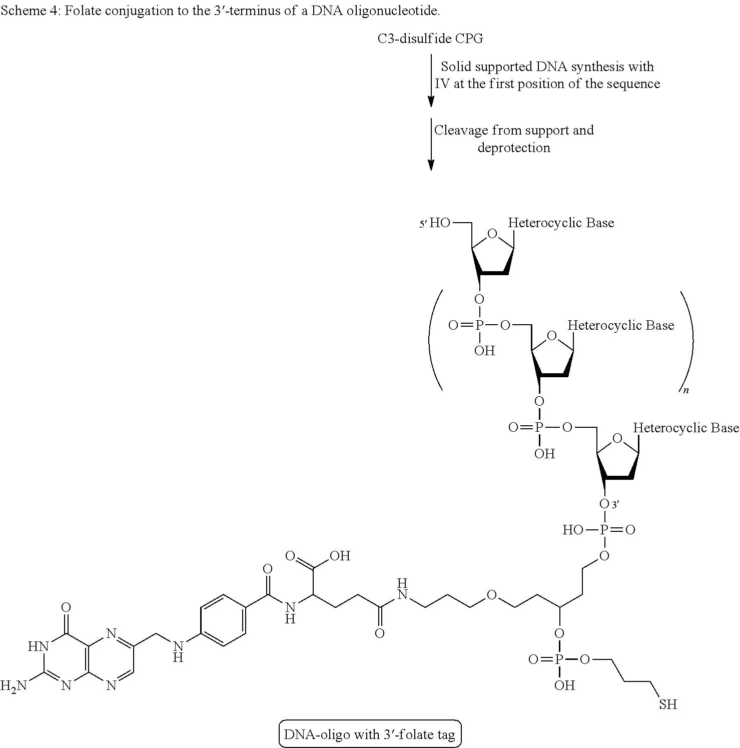

In certain embodiments, compounds of formula I may be conjugated to therapeutic or diagnostic compounds of interest to facilitate uptake of the conjugate into cells of interest. For example, compounds with anticancer properties may be conjugated to compounds of formula I. These conjugates may be used to treat cancers which over-express folate receptors. Schemes 5 and 6 provide illustrative examples of the use of II in the formation of folic acid conjugates of two anticancer compounds, Pentostatin and Podophyllotoxin. In Scheme 5,3′-5′-di-(p-toluolyl)-Pentostatin is treated with II and ETT in a suitable solvent such as acetonitrile. The resulting phosphite is oxidized to the phosphotriester by treatment with iodine in a mixed solvent of pyridine and THF. Finally, the p-toluolyl and cyanoethyl protecting groups are removed under basic conditions, for example K₂CO₃ in methanol to afford the folic acid conjugate of Pentostatin. In Scheme 6, the same sequence of reactions is applied to Podophyllotoxin to make its folic acid conjugate. This strategy can be employed with any compound that has a hydroxyl group available to react with the phosphoramidite moiety of compounds of the present invention.

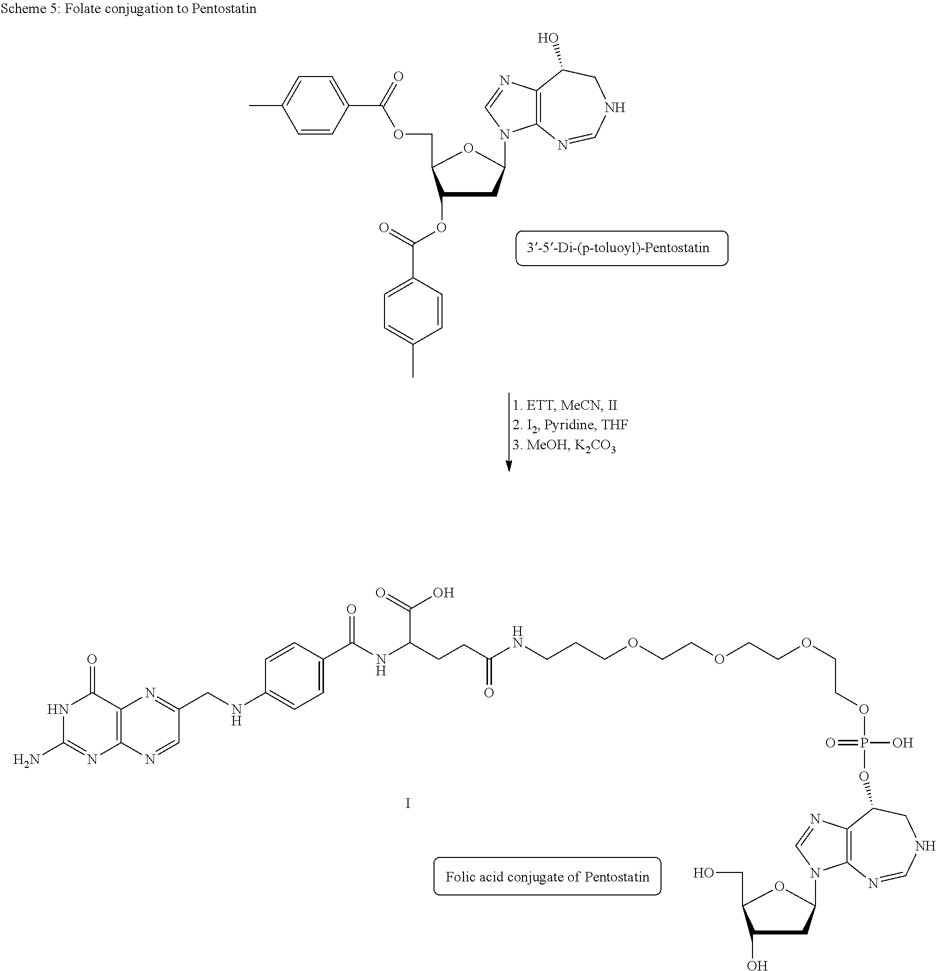

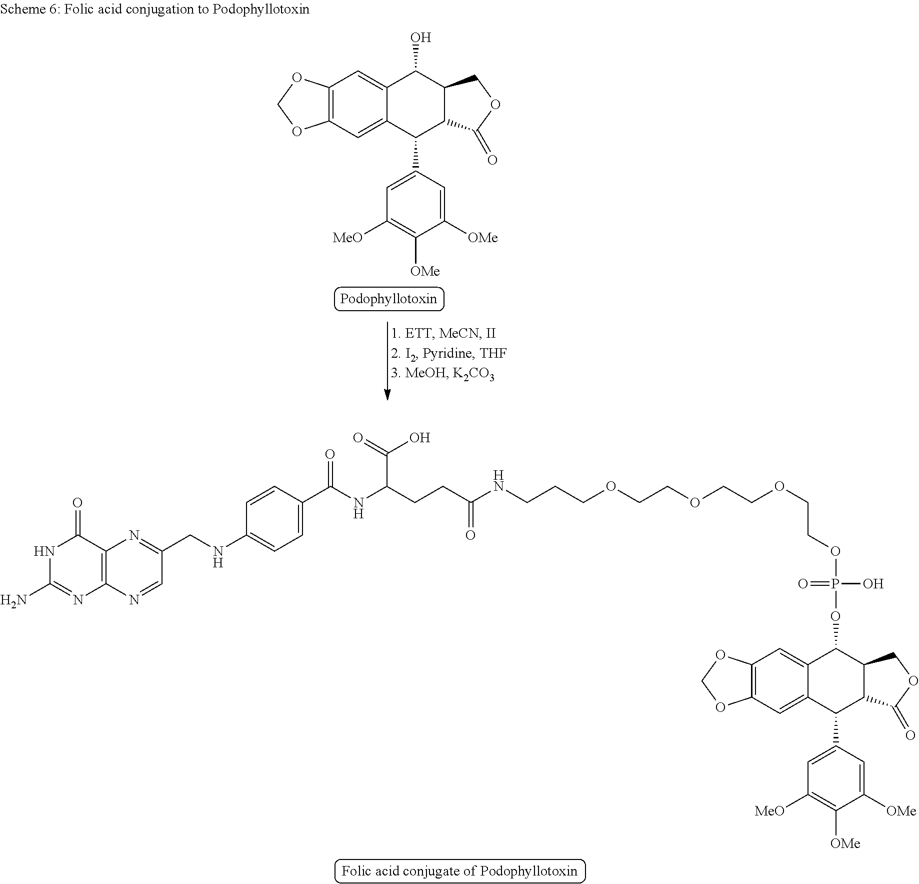

### EXAMPLES

### Example 1

### (S)-5-tert-butyl 1-methyl 2-(4-(2,2,2-trifluoro-N-((2-isobutyramido-4-oxo-3,4-dihydropteridin-6-yl)methyl)acetamido)benzamido)pentanedioate

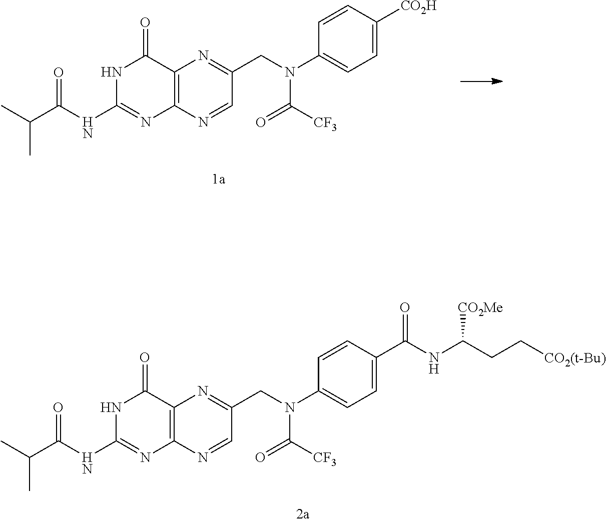

A solution of 1a (0.20 g, 0.41 mMol) in anhydrous DMF (1.7 mL) was treated with HBTU (0.158 g, 0.41 mMol), followed by diisopropylethylamine (0.08 mL, 2.01 mMol) under an atmosphere of anhydrous nitrogen, at room temperature, for 20 minutes. A solution of L-glutamic acid γ-t-butyl ester α-methyl; ester hydrochloride (0.10 g, 0.41 mMol) in DMF (0.5 mL) was added and the reaction mixture was stirred at room temperature overnight. The reaction mixture was poured onto 200 g ice and stirred rapidly until the ice melted. The solids were collected by filtration and washed with pentane. Further drying under high vacuum (0.1 mmHg, room temperature, 24 hours) gave 2a as an orange solid (0.28 g). MS (AP+) 700.6 (M+Na). MS (AP−) 676.7 (M−1).

### Example 2

### (S)-5-methoxy-5-oxo-4-(4-(2,2,2-trifluoro-N-((2-isobutyramido-4-oxo-3,4-dihydropteridin-6-yl)methyl)acetamido)benzamido)pentanoic acid

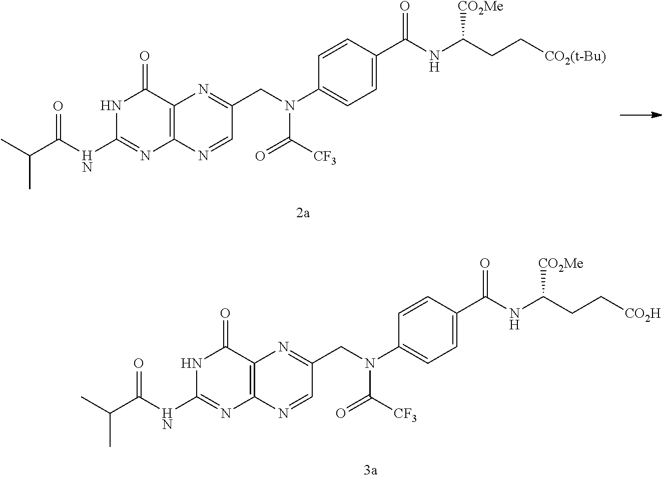

A solution of diester 2a (2.3 g, 3.3 mMol) in DCM (65 mL) was treated with TFA (10 mL) at room temperature. After 3 hours, the solution was concentrated to an orange oil, and co-evaporated with 2×50 mL DCM, 1×50 mL EtOAc, and 1×50 mL 1:1 EtOAc/hexanes. The resulting oil was dissolved in 20 mL EtOAc (ethyl acetate), and was added dropwise over 30 minutes to 600 mL rapidly stirred hexane. The solution was stirred for 30 minutes, then let settle for 30 minutes. The solution was then decanted from the solids. The solids were dissolved in DCM and concentrated. Further drying under high vacuum (0.1 mmHg, room temperature, 24 hours) gave 3a as a light orange solid (2.05 g) which was used in Example 3 without further analysis or purification.

### Example 3

### (S)-methyl 1-hydroxy-14-oxo-17-(4-(2,2,2-trifluoro-N-((2-isobutyramido-4-oxo-3,4-dihydropteridin-6-yl)methyl)acetamido)benzamido)-3,6,9-trioxa-13-azaoctadecan-18-oate

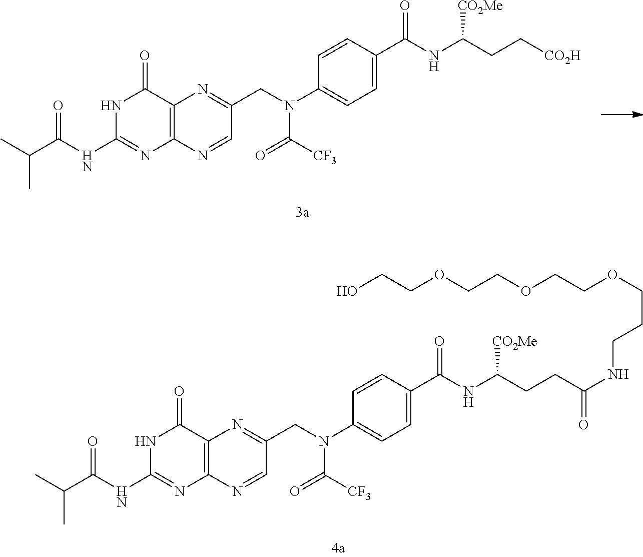

A solution of 3a (2.06 g, 3.31 mMol), HOBT (0.45 g, 3.31 mMol), EDAC hydrochloride (0.51 g, 3.31 mMol) in anhydrous DMF (10 mL) was treated with DIEA (N,N-Diisopropylethylamine) (0.7 mL, 4.0 mMol),) under an atmosphere of anhydrous nitrogen, and stirred at room temperature, for 20 minutes. 12-Amino-3,6,9-trioxadodecan-1-ol (0.83 g, 4.0 mMol) was added and the reaction mixture was stirred at room temperature for 48 hours. The reaction mixture was concentrated to remove DMF, co-evaporated from 2×75 mL DCM and concentrated to an oil. The crude material was purified by silica gel chromatography eluting with 0.5-9% MeOH in DCM. TLC-pure fractions were combined and concentrated to give a pale orange solid. Further drying under high vacuum (0.1 mmHg, room temperature, 24 hours) gave 4a as a pale orange solid (0.9 g). MS (AP+) 833.7 (M+Na). MS (AP−) 809.8 (M−1).

### Example 4

### (17S)-methyl 1-(((2-cyanoethoxy)(diisopropylamino)phosphino)oxy)-14-oxo-17-(4-(2,2,2-trifluoro-N-((2-isobutyramido-4-oxo-3,4-dihydropteridin-6-yl)methyl)acetamido)benzamido)-3,6,9-trioxa-13-azaoctadecan-18-oate.

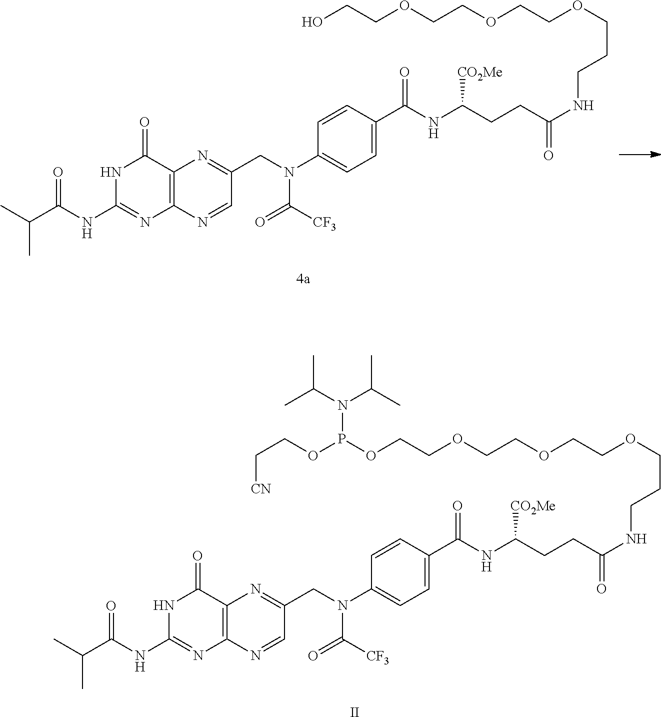

A solution of 4a (0.90 g, 1.11 mMol) in anhydrous DCM (20 mL) was treated with bis-reagent (0.88 mL, 2.5 mMol), followed by diisopropylammonium tetrazolide (19 mg, 0.11 mMol) under an atmosphere of anhydrous nitrogen, at room temperature, for 4 hours. The resulting solution was partitioned between DCM (50 mL) and distilled water (35 mL). The organic phase was separated and washed again with distilled water (35 mL). The organic phase was dried over Na₂SO₄, filtered, and concentrated to a thick oil at reduced pressure. The oil was dissolved in DCM (5 mL) and added dropwise to vigorously stirred n-pentane-triethylamine (99.5:0.5, 120 mL). The hazy pentane was then decanted from the precipitate. The precipitate was redissolved in DCM (5 mL) and added dropwise to vigorously stirred n-pentane-triethylamine (99.5:0.5, 120 mL). The precipitate was dissolved in ethyl acetate (25 mL) and evaporated to a thick oil at reduced pressure. Further drying under high vacuum (0.1 mmHg, room temperature, 24 hours) gives II as a crisp, slightly yellow-colored foam (0.97 g) of suitable purity for use in oligonucleotide synthesis. TLC (Et₃N deactivated silica on glass, eluted with 92% DCM-8%

i-PrOH)R_{f}=0.65. MS (AP+) 1033 (M+Na). MS (AP−) 1009 (M−1). ³¹P-NMR (CD₃CN, δ) 148.54 (singlet).

### Example 5

### 5′-Folate modified-T₆

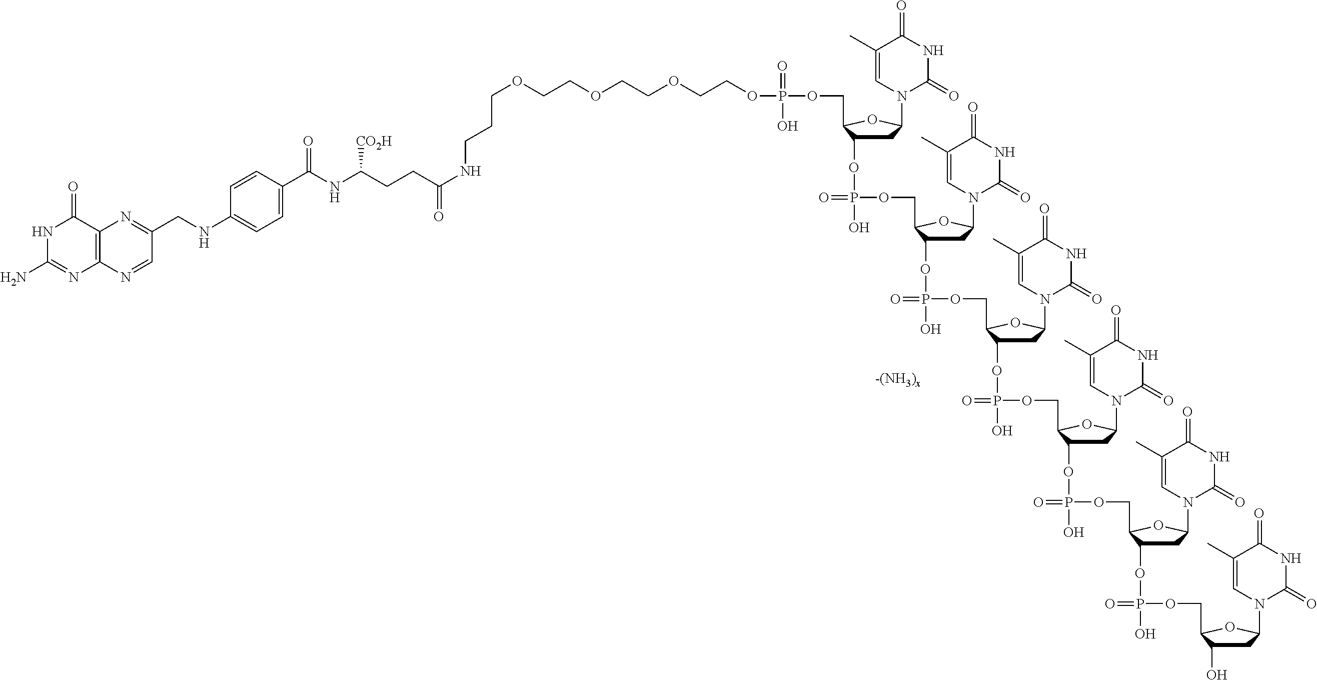

Using a Millipore Expedite (8900 series) nucleic acid synthesis system (Billerica, Mass.), freshly prepared reagent solutions installed as follows were installed in the reagent bottles as follows:
Wash A—anhydrous acetonitrile
Deblock—3% Trichloroacetic acid in anhydrous dichloromethane
Oxidizer—0.02M iodine in tetrahydrofuran/water/pyridine
Capping reagent A—acetic anhydride/anhydrous tetrahydrofuran
Capping reagent B—16% 1-methylimidazole in anhydrous tetrahydrofuran/pyridine
Wash reagent—anhydrous acetonitrile
Activator—0.25M 5-ethylthiotetrazole in anhydrous acetonitrile
Amidites: Thymidine-CEP and II from Example 4 (0.067M solutions in anhydrous acetonitrile)

The reagent lines were purged and pumps primed. Two synthesis columns containing 200 nM of DMT-T-lcaa-CPG were installed.

The instrument run parameters were then set as follows:
Column—1.
Sequence—3′-TTTTTTX-5′ (wherein T denotes a Thymidine residue and X denotes the folate tag.)
Protocol—CYCLE T (a 23 step protocol for reagent additions, reaction times, and washes known to be optimized for each coupling of Thymidine-CEP, as provided in the synthesizer software.)
Final DMT—On (The folate tag is not subjected to DMT cleavage reagent since in this case there is no DMT protection present.)
Column—2.
Sequence—3′-TTTTTT-5′
Protocol—CYCLE T
Final DMT—Off

Folate-T₆-lcaa-CPG was synthesized in column 1 using CYCLE T conditions for each T residue and for the final coupling of II. T₆-lcaa-CPG was synthesized in column 2 using CYCLE T conditions for each T residue. The output of the colorimetric monitoring of each deblock step was recorded by the synthesizer's computer. The integrated values for each of the 6 deblock steps were consistent with the successful synthesis of T₆-lcaa-CPG on both columns, however the folate coupling step at the 5′-terminus on column 1 is DMT-silent. In order to verify that the folate coupling was successful, each column was further subjected to treatment 28-30% ammonium hydroxide for 15 minutes at room temperature in order to cleave the oligonucleotide from the CPG support. The resulting solution of oligonucleotide was further heated at 55° C. for 1 hour to ensure complete removal of the cyanoethyl protecting groups. The resulting solutions of Folate-T₆ and T₆ were each sparged with a stream of nitrogen to expel excess ammonia then diluted with an equal volume of acetonitrile. Reversed phase HPLC analysis on a Waters Spherisorb ODS-2 column (150×4.6 mm) eluting at 1.0 mL/min with a gradient of 5 to 35% acetonitrile in 0.1 M triethylammonium acetate showed a retention time for T₆ of 11.7 minutes (DNA product from column 2) and a retention time for Folate-T₆ of 14.0 minutes (DNA product from column 1). Furthermore, an integration ratio of 99 (Folate-T₆) to 1 (T₆) was observed for the peaks in the HPLC chromatogram of DNA product from column 1, thereby confirming the successful coupling of II at the 5′-end of the T₆ oligonucleotide with high efficiency.

What is claimed is:

1. A compound of Formula I: 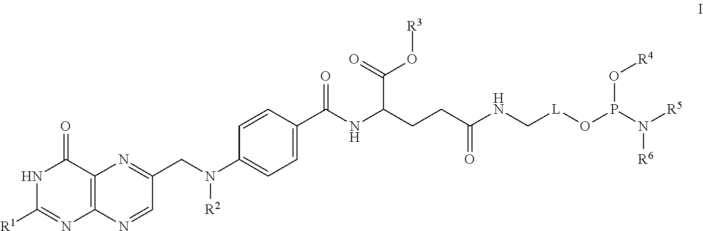
wherein:
R¹ is c-hexyl-C(═O)NH, c-pentyl-C(═O)NH, (CH₃)₂CHC(═O)NH, CH₃CH₂C(═O)NH, CH₃C(═O)NH, PhC(═O)NH, 2-CH₃-Ph(C═O)NH, 4-CH₃-Ph(C═O)NH, 2,4-(CH₃)₂-Ph(C═O)NH, 2,6-(CH₃)₂-Ph(C═O)NH, 2,4,6-(CH₃)₃-Ph(C═O)NH, Fmoc-NH, (CH₃)₃SiCH₂CH₂OC(═O)NH, DMT-OCH₂CH₂OC(═O)NH, NCCH₂CH₂OC(═O)NH, Cl₃CCH₂OC(═O)NH, CH₃C(═O)OCH₂CH₂OC(═O)NH, CH₃C(═O)OCH₂CH₂C(CH₃)₂C(═O)NH, DMT-OCH₂CH₂C(CH₃)₂OC(═O)NH, DMT-OCH₂CH₂C(Ph)₂OC(═O)NH, DMT-OCH₂CH₂C(4-Cl-Ph)₂OC(═O)NH, CF₃C(═O)NHCH₂CH₂C(═O)NH, CF₃C(═O)NHCH₂CH₂C(CH₃)₂C(═O)NH, (CH₃)₂N—C═N, (i-Bu)₂N—C═N, (n-Bu)₂N—C═N, (i-Pr)₂N—C═N, (n-Pr)₂N—C═N, (Et)₂N—C═N, (CH₃)₂N—C═N, or (1-imidazolyl)-C═N;
R² is CH₃C(═O), CF₃C(═O), Cl₃C(═O), Fmoc, SEM, H₂C═CHCH₂, C₂H₅, CH₃, or H;
R³ is CH₃, C₂H₅, CH₂CH₂CN, CH₂CH₂Si(CH₃)₃, Cl₃CCH₂, CH₂(9-fluorenyl), or (CH₂)ₙO-DMT, wherein n is an integer from 2 to 6;
R⁴ is CH₂CH₂CN or CH₃;
R⁵ and R⁶ are each independently selected C₁-C₆-alkyl, or may be taken together to form —(CH₂)₄— or —(CH₂)₅—; and
L is —(CH₂)ₘ—, (CH₂CH₂O)ₘCH₂CH₂—, —CH₂(OCH₂CH₂)ₘ—, —(CH₂)ₘOCH₂CH(CH₂O-DMT)-, —(CH₂CH₂O)ₘCH₂CH₂OCH₂CH(CH₂O-DMT)-, —CH₂(OCH₂CH₂)ₘOCH₂CH(CH₂O-DMT)-, —(CH₂)ₘOCH₂CH₂CH(CH₂CH₂O-DMT)-, —(CH₂CH₂O)ₘCH₂CH₂CH(CH₂CH₂O-DMT)-, —CH₂(OCH₂CH₂)ₘOCH₂CH₂CH(CH₂CH₂O-DMT)-, —(CH₂)ₘCONHCH(CH₂O-DMT)CH₂—, —(CH₂CH₂O)ₘCH₂CH₂CONHCH(CH₂O-DMT)CH₂—, —(CH₂CH₂O)ₘCH₂CONHCH(CH₂O-DMT)CH₂—, or —CH₂(OCH₂CH₂)ₘOCH₂CONHCH(CH₂O-DMT)CH₂—, wherein m is an integer from 1 to 10.

2. The compound of claim 1, wherein R¹ is c-hexyl-C(═O)NH, c-pentyl-C(═O)NH, (CH₃)₂CHC(═O)NH, CH₃CH₂C(═O)NH, CH₃C(═O)NH, PhC(═O)NH, 2-CH₃-Ph(C═O)NH, 4-CH₃-Ph(C═O)NH, or 2,4-(CH₃)₂-Ph(C═O)NH.

3. The compound of claim 1, wherein R² is CCl₃C(═O), CF₃C(═O), or H.

4. The compound of claim 1, wherein R³ is CH₃, C₂H₅, CH₂CH₂CN, or CH₂(9-fluorenyl).

5. The compound of claim 1, wherein R⁴ is CH₂CH₂CN, R⁵ is i-Pr, and R⁶ is i-Pr.

6. The compound of claim 1, wherein L is —(CH₂CH₂O)ₘCH₂CH₂—, —CH₂(OCH₂CH₂)ₘ—, —(CH₂CH₂O)ₘCH₂CH₂OCH₂CH(CH₂O-DMT)-, —CH₂(OCH₂CH₂)ₘOCH₂CH(CH₂O-DMT)-, —(CH₂CH₂O)ₘCH₂CH₂CH(CH₂CH₂O-DMT)-, or —CH₂(OCH₂CH₂)ₘOCH₂CH₂CH(CH₂CH₂O-DMT)-, wherein m is an integer from 1 to 10.

7. The compound of claim 6, wherein R¹ is (CH₃)₂CHC(═O)NH, R² is CF₃C(═O), or H, R³ is CH₃, R⁴ is CH₂CH₂CN, R⁵ is i-Pr and R⁶ is i-Pr.

8. The compound of claim 6, wherein m is an integer from 1 to 4.

9. The compound of claim 1, wherein said compound is represented by structure II, 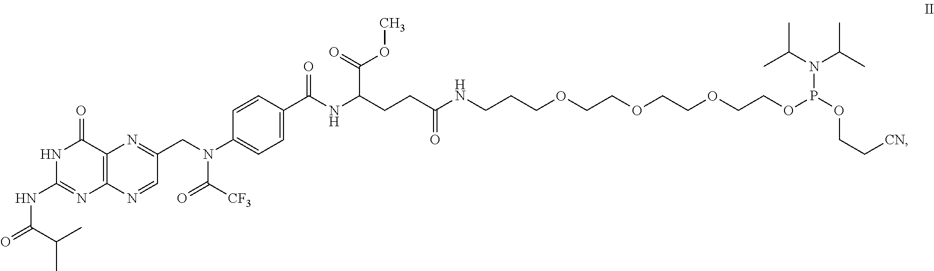
including all four possible individual diastereomers and mixtures thereof.

10. The compound of claim 1, wherein said compound is represented by structure III, 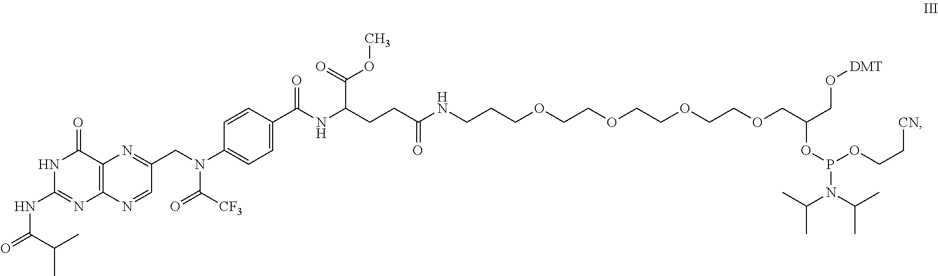
including all eight possible individual diastereomers and mixtures thereof.

11. The compound of claim 1, wherein said compound is represented by structure IV, 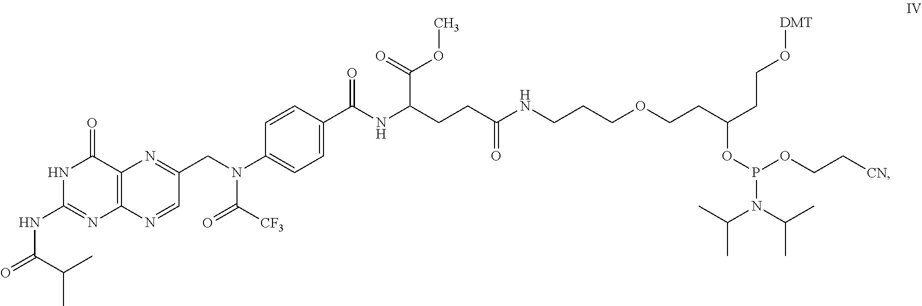
including all eight possible individual diastereomers and mixtures thereof.

12. The compound of claim 1, wherein said compound contains one or more atoms that are stable heavy isotopes selected from ²H, ¹³C, ¹⁵N, and/or ¹⁸O.

13. The compound of claim 12, wherein said compound contains at least one ²H isotope as a replacement for a ¹H atom.

14. The compound of claim 12, wherein said compound contains at least one ¹³C isotope as a replacement for a ¹²C atom.

15. The compound of claim 12, wherein said compound contains at least one ¹⁵N isotope as a replacement for a ¹⁴N atom.

16. The compound of claim 12, wherein said compound contains at least one ¹⁸O isotope as a replacement for an ¹⁶O atom.

17. The compound of claim 1, wherein said compound contains one or more radioactive isotopes selected from the group consisting of: ³²P, ³³P, ¹⁴C, ³H, ¹⁸F, ¹²³I, ¹²⁵I, and ¹³¹I.

18. The compound of claim 17, wherein said compound contains at a ³²P or ³³P isotope as a replacement for the ³¹P atom.

19. The compound of claim 17, wherein said compound contains at least one ¹⁴C isotope as a replacement for a ¹²C atom.

20. The compound of claim 17, wherein said compound contains at least one ³H, ¹⁸F, ¹²³I, ¹²⁵I or ¹³¹I isotope as a replacement for a ¹H atom.
